(19) United States
(12) Patent Application Publication
(10) Pub. No.: US 2011/0166934 A1
(43) Pub. Date: Jul. 7, 2011

(54) TARGETED ADVERTISING BASED ON REMOTE RECEIPT ANALYSIS

(76) Inventors: Ofer Comay, Tel Aviv (IL); Paz Kahana, Newton, MA (US); Vitaliy Khodkevich, Tel Aviv (IL)

(21) Appl. No.: 13/050,171

(22) Filed: Mar. 17, 2011

Related U.S. Application Data
(63) Continuation-in-part of application No. 12/873,040, filed on Aug. 31, 2010.
(60) Provisional application No. 61/275,449, filed on Aug. 31, 2009.
(60) Provisional application No. 61/340,399, filed on Mar. 17, 2010.

(51) Int. Cl. G06Q 30/00

(52) U.S. Cl. 705/14.53

(57) ABSTRACT

A computer implemented method performs targeted advertising based on remote receipt analysis. The method includes receiving an image of a receipt over a network and automatically performing optical character recognition on the image of the receipt to obtain a machine-encoded text. The method further includes automatically extracting transaction data from the machine-encoded text and automatically distributing commercial data to a user console based on the transaction data.

### CROSS REFERENCE TO RELATED APPLICATIONS

The present invention is a continuation in part of U.S. patent application Ser. No. 12/873,040, filed on Aug. 31, 2010, which in turn claims the priority benefit of U.S. provisional patent application No. 61/275,449 filed on Aug. 31, 2009. In addition, the present invention claims the priority benefit of U.S. provisional patent application No. 61/340,399 filed on Mar. 17, 2010, all of which are incorporated in its entirety herein by reference.

### FIELD OF THE INVENTION

The present invention relates to network based applications. More particularly, the present invention relates to a method and system for providing remote receipt analysis over a network.

### BACKGROUND OF THE INVENTION

Document capture has traditionally referred to a capability of scanning or digitizing a paper document for electronic storage in a computer system. For example, the digitized document may be entered as part of a database. In general, a system that performs such tasks, often referred to as a document management system, is based on an individual computer of on a networked system. With the advent of Internet-based technology, it has become possible to construct a document management system that can store data via a website.

A document management system typically enables indexing the documents or otherwise enables organization of the stored documents. For example, organization of the documents may enable retrieving a document as needed. For example, indexing or document retrieval may be based on key words that are associated with a document.

Digitization of documents may also be employed in order to extract data from the documents. For example, content of a document may be added to a database where data from the content may be available for further processing or analysis.

Optical character recognition (OCR) technology is often used to extract data from a document. For example, application of OCR technology may convert a digitized image of a document to text or symbols. Typically, application of an OCR program yields an OCR text that is a close approximation to the original text. However, the OCR text typically includes errors that may result from images that the OCR program failed to correctly identify, or that the OCR program identified in an ambiguous manner. A human user typically must compare the OCR text with the original document to check or verify the accuracy of the OCR text, and correct as needed. Both the running of the OCR program and accuracy checking by a human user may be time consuming tasks.

In addition, a document may include features that may present additional difficulties to OCR. For example, a simple OCR program may not be capable of interpreting handwritten text, text containing unusual symbols or fonts, or text written or printed on a non-uniform background. However, a sophisticated OCR program capable of overcoming these difficulties may be expensive, or otherwise difficult for a typical user to obtain or run.

Once a reliable OCR text is obtained, data may be extracted from the OCR text and applied to various applications.

It is an object of the present invention to provide a network based system and method of analyzing a document provided by a remote user, and for incorporating data extracted from the document to provide information needed by the user.

Other aims and advantages of the present invention will become apparent after reading the present invention and reviewing the accompanying drawings.

### SUMMARY OF THE INVENTION

According to embodiments of the present invention, there is provided a method for targeted advertising. The method may include receiving an image of a receipt that was acquired by a user device of a user and sent over a network, automatically performing optical character recognition and other analyses on the image of the receipt to obtain a machine-encoded text, automatically extracting transaction data from the machine-encoded text, and automatically distributing commercial data to a user console of the user based on the transaction data.

Furthermore, according to embodiments of the present invention, the method may include soliciting input from a plurality of operators, and comparing input received from the plurality of operators.

Furthermore, according to embodiments of the present invention, there is provided a computer program product stored on a non-transitory tangible computer readable storage medium for targeted advertising. The computer program may include code for receiving an image of a receipt that was acquired by a user device of a user and sent over a network, automatically performing optical character recognition on the image of the receipt to obtain a machine-encoded text, automatically extracting transaction data from the machine-encoded text, and automatically distributing commercial data to a user console of the user based on the transaction data.

Furthermore, according to embodiments of the present invention, the computer program may include code for soliciting input from a plurality of operators, and comparing input received from the plurality of operators.

Furthermore, according to embodiments of the present invention, there is provided a data processing system for targeted advertising. The data processing system may include a processor, and a computer usable medium connected to the processor, wherein the computer usable medium contains a set of instructions for targeted advertising, wherein the processor is designed to carry out a set of instructions to receive an image of a receipt that was acquired by a user device of a user and sent over a network, automatically perform optical character recognition on the image of the receipt to obtain a machine-encoded text, automatically extract transaction data from the machine-encoded text, and automatically distribute commercial data to a user console of the user based on the transaction data.

Furthermore, according to embodiments of the present invention, the processor is designed to carry out a set of instructions to solicit input from a plurality of operators, and compare input received from said plurality of operators.

Furthermore, according to embodiments of the present invention, the transaction data may include: vendor name, vendor phone number, store address, date of purchase, products purchased, price of each product and the total price paid.

Furthermore, according to embodiments of the present invention, automatically distributing commercial data to the user console may include querying a user database, the user database associating users, products, prices and various stores and vendors, querying a vendor database associating vendors, ads and categories of target users, and distributing commercial data to a selected category of target users as defined by the vendor database.

Furthermore, according to embodiments of the present invention, the categories of target users may be defined based on user characteristics selectable from a list comprising: geographic location of stores a user shop in, category of items the user purchases, specific items the user purchases and the stores the user shop in.

Furthermore, according to embodiments of the present invention, distributing commercial data to the user console may include sending commercial data addressed to the user console automatically or on demand.

Furthermore, according to embodiments of the present invention, the commercial data may include ads and coupons.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic diagram of a remote receipt analysis system in accordance with embodiments of the present invention;

FIG. 2 shows a flowchart illustrating a method for remote receipt analysis, in accordance with embodiments of the present invention;

FIG. 3 is a schematic diagram of a targeted advertising system in accordance with embodiments of the present invention; and

FIG. 4 which shows a flowchart illustrating a method for targeted advertising, in accordance with embodiments of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Aspects of the present invention, as may be appreciated by a person skilled in the art, may be embodied in the form of a system, a method or a computer program product. Similarly, aspects of the present invention may be embodied as hardware, software or a combination of both. Aspects of the present invention may be embodied as a computer program product saved on one or more computer readable medium (or mediums) in the form of computer readable program code embodied thereon.

For example, the computer readable medium may be a computer readable signal medium or a computer readable non-transitory storage medium. A computer readable storage medium may be, for example, an electronic, optical, magnetic, electromagnetic, infrared, or semiconductor system, apparatus, or device, or any combination thereof.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers.

Aspects of the present invention are described hereinabove with reference to flowcharts and/or block diagrams depicting methods, systems and computer program products according to embodiments of the invention.

A system for remote document analysis, in accordance with embodiments of the present invention, provides a remote system for analysis of a document image submitted by an appropriate user device. The document typically includes a receipt for an amount paid for one or more products or services. For example, a user may photograph or scan the document with an appropriate user device to which the user has access. For example, the user may photograph a document using a digital camera that is incorporated into a mobile telephone. The user may then send the digital photograph from the mobile telephone to a remote processing center via a network. For example, the user may use an email or Internet function of the mobile to send the digital photograph to the remote processing center. The user device may be programmed with an appropriate user program. For example, the user program may be configured to transmit the document image to an appropriate processing center.

Alternatively, the user device may include a digital camera that is connectable to a computer, or to a webcam or scanner that is connected to the computer. The user may then use an email or Internet function of the computer to transmit the image to the remote processing center. Alternatively, the user may use a facsimile machine or other telephone-based image transmission device to transmit an image of the document to the remote processing center.

A user device may be configured to transmit any required identification or other data required by the processing center for appropriate subsequent processing of the submitted document. For example, such data may include a user name, one or more user identification numbers or codes, a current location of the user device, method of payment, credit card number, or a date and time. Other information required by the processing center may be stored in a database maintained by the processing center. Alternatively, the information may be submitted by the user device in association with the document image. For example, a program running on the user device may prompt the user to enter the information. Alternatively, the information may be stored on a memory unit associated with the user device. Programming required for interacting with the processing center may be installed on the user device, or may be accessible by the user device via a network.

The processing center may include one or more processing units. For example, each processing unit may include a computer, or a plurality of intercommunicating computers, that is programmed to perform one or more processing tasks. The processing unit may be configured to receive a transmitted document image.

A processing unit at the processing center may apply various processing techniques to a received document image. For example, the processing unit may apply one or more image enhancement or image adjustment techniques in order to obtain an image suitable for further processing. The processing unit may apply OCR technology in order to identify text or other content of the document image. Application of OCR technology may then result in machine encoded text. For example, the machine encoded text may include one or more strings of text characters. A human operator at the processing center may review the results in order to verify correct interpretation of the OCR results, or to provide any required human input. For example, the human operator may select a correct result from several possibilities, or provide an interpretation for unidentifiable characters.

A processing unit may perform additional analysis of a document image. For example, the processing unit may extract data from OCR results. The processing unit may, for example, add the extracted data to a database, use the extracted data to query a database, may store the data in a retrievable manner, or may use the data as input to a program or application.

Typically, the processing unit may extract an amount paid from the OCR results. For example, the processing unit may be configured to recognize an amount paid by identifying text that is typically positioned adjacent to a number representing an amount paid.

Typically, as a result of analysis of the document image, the processing unit may generate a message and send it to a destination user device. The destination user device may be identical with, or associated with, the user device from which the document image was submitted, or may be a different device.

For example, an expense report module, in accordance with some embodiments of the present invention, may be included in a processing unit. The expense report module may be configured to create an expense report on the basis of one or more document images.

For example, a subscriber to an expense report service may operate a client program on a user device. The user device may be configured to submit an image of a receipt for a payment that is to be included in the expense report.

For example, an expense report module of a processing unit may be configured to recognize text that represents an amount paid, or a component of an amount paid. In addition, the expense report module may be configured to distinguish among various components of the amount paid. For example, the expense report module may be configured to distinguish between an expense that is refundable or tax-deductible, and one that is not.

The expense report module may generate an expense report based in part upon the receipt data. For example, an expense report may also include any identifying or other information that may be associated with the expense report. Such information may include information that is stored in a database that is associated with the expense report module. Alternatively, the information may be transmitted by a user device in association with the image of the receipt.

The expense report module may generate an expense report whenever a document image, or set of document images, is received. Alternatively or in addition, the expense report module may store any received data and generate an expense report at a predetermined time. For example, the expense report module may generate a weekly, monthly, or annual expense report at predetermined dates. As another example, the expense report module may generate an expense report at the end of a business trip or meeting. The end of a business trip may be indicated by a scheduled return date. Alternatively, a user operating a user device may transmit a message or signal to the expense report module at the beginning and end of the business trip or meeting.

The expense report module may send the expense report as a message to a device associated with the user who submitted the document image. Alternatively or in addition, the expense report module may send the expense report to a designated recipient (e.g. an accountant or accounting department).

A processing unit, in accordance with some embodiments of the present invention, may include a household management module. For example, a user may subscribe to a household management service. A household management module may analyze a received image of document and extract data from the document. For example, a user device may transmit an image of a store receipt to a processing unit that includes a household management module. The household management module may identify on the receipt image such information as: a name and location of a store, a date of purchase, products purchased, and the price of each product.

A household management module in accordance with embodiments of the present invention, may maintain a database of products and prices at various stores. For example, information from a received receipt image may be added to the database as the information is acquired. A received receipt image may also be used to query the database. For example, a query to the database based on information from the receipt image may be used to compare prices. For example, the household management module may send to a user a listing or sum of what the same products would have cost if purchased at another store. The query may be limited to a particular geographical area. For example, the query may be limited to stores in a limited geographical area near the store that issued the receipt. Such a query may help the user select a store for future purchases. On the other hand, the query may include stores in a wide geographical region so as to enable regional comparisons of prices. The results of the query, such as a price comparison, may be sent to the user or a user device in the form of a message.

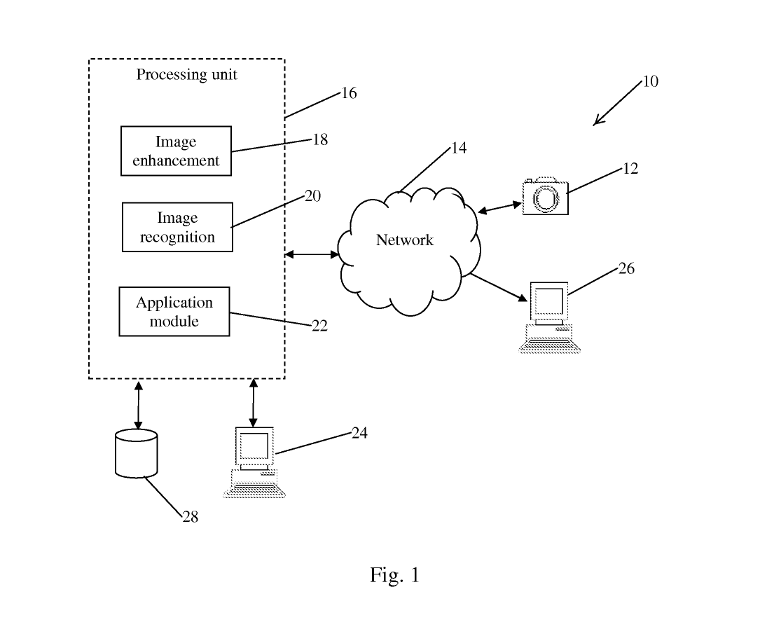

FIG. 1 is a schematic diagram of a remote receipt analysis system in accordance with embodiments of the present invention. Receipt analysis system 10 includes user device 12 that may communicate with a processing unit 16 via network 14. User device 12 may include a digital imaging device in combination with a device capable of transmitting a digital image over network 14. For example, image acquisition device may include a digital camera or a scanner that may communicate with a computer, a fax machine, or a mobile telephone or other mobile communications device with a built-in camera. Network 14 may include, for example, a wired or wireless telephone network, a wired or wireless computer network, or the Internet.

Processing unit 16 may be typically located at a remote processing center. For example, a remote processing center may be maintained by remote document analysis provider. Processing unit 16 may represent a single processor or computer, or a plurality of intercommunicating processors or computers. A remote document analysis provider may provide one or more remote document analysis services. Each of the various services may be provided on a separate processing unit 16. Alternatively, a single processing unit 16 may be configured to provide several remote data analysis services. A processing unit 16 may be configured to provide service to a single group of users, for example, users that are associated with a single organization. Alternatively, processing unit 16 may be configured to provide service to several groups of users.

Processing unit 16 may be configured to perform a variety of functions. Each of these functions may be represented schematically as separate modules of processing unit 16. Each module may represent a separate processor or computer, or to various programming or software units that operate on a single processor. For example, each module may represent a program or subprogram.

Processing unit 16 may include an image enhancement module 18. Image enhancement module 18 may be configured to perform one or more image enhancement functions. For example, image enhancement module 18 may be configured to distinguish between printed text and a background, may adjust image brightness, contrast, or sharpness in order to facilitate text recognition, and may correct for distortion of the image.

Processing unit 16 may include an image recognition module 20. Image recognition module 20 may be configured to perform one or more image recognition operations on a document image. The image recognition operations may include, for example, OCR. Image recognition operations may also include recognizing a type of document, and identifying particular data within the document. For example, a document recognition operation may include identifying a title of the document and classifying the document on the basis of the text content of the identified title. Identification of particular data may include identifying text on the basis of its position within the document, or on its proximity to a key word. For example, a total amount paid may be identified as text in currency format that appears at a particular location in the document (e.g. lowermost on the document, or at the top of or at the bottom of column of prices), that is distinguished from other text (e.g. larger font size or bold type); that appears in a particular context (e.g. next to the word “total” or “amount paid”), or text that meets the best combination of these criteria. Image recognition operations may include recognizing an itemized list of purchased items and their prices, and an amount of sales tax or value added tax paid. For example, a list may be recognized as a vertical column of text in currency format appearing next to an aligned column of text in the form of verbal descriptions (e.g. being recognized as a list of products or services) or Universal Product Code (UPC) numbers. Image recognition operations may also include recognizing a receipt date as text in date format. When several dates appear in the receipt, the most appropriate date may be selected using criteria such as location on the receipt image, or a keyword that appears near the date. Image recognition may also recognize the vendor, typically using a database of vendor information (including, e.g. vendor names, logos, addresses, or phone numbers).

Image recognition module 20 may interact with operator console 24. Operator console 24 may enable a human operator to review results of image recognition module 20. For example, operator console 24 may include one or more output devices, such as a display screen, printer, or speaker, and one or more input devices, such as a keyboard, mouse, trackball, touch-sensitive screen, pointer, or joystick. Operator console 24 may also enable a human operator to provide human input when required. For example, automatic running of image recognition module 20 may fail to identify text or information regarding a document, or may lead to an ambiguous result. In such cases, human input via operator console 24 may enable correct interpretation of a submitted document image.

Processing unit 16 may include one or more application modules 22. Each application module 22 may be configured to perform one or more operations associated with an application of remote receipt analysis system 10. An application module 22 may be configured to provide operations for an application such as expense report preparation, workflow management, or household management. For example, an application to be run may be selected on the basis of user input that is submitted from user device 12 in association with a submitted document image. Alternatively, an application may be selected on the basis of user subscription information. Alternatively, an application may be selected on the basis of a recognized property of the document. For example, a receipt that is identified as being associated with travel or business expenses may automatically activate an expense report application. On the other hand, a receipt identified as an itemized receipt from a food or department store may automatically activate a household management application. Automatic selection of an application may be subject to verification by a user via user device 12, or by an operator via operator console 24.

An application module 22 may communicate with a data storage device 28. Data storage device 28 may represent a single storage device, such as a hard disk, or a plurality of data storage devices that may be accessed by processing unit 16. For example, a data storage device 28 may include one or more databases. An application module 22 may add data that was extracted from a submitted document to a database on data storage device 28. Alternatively, an application module 22 may use extracted data to query a database on data storage device 28. For example, a household management application may add price data from a submitted shopping receipt to a database, or query the database in order to find a price for the same product at another store. As another example, data may be transferred to a service provider that provides accounting, auditing, expense reporting, or other financial services.

Typically, an application module 22 may generate a result. For example, an expense report application may generate an expense report. As another example, a household management module may generate comparative price information. Such comparative information may include: a list of prices at other stores, the location of a store with lower prices, or notification of a current sale or promotional campaign. The comparative price information may relate to a geographic location, or to a product or class of products. Typically, processing unit 16 may transmit a result generated by an application module 22 as a message via network 14 to a user console 26. User console 26 may be identical to, or associated with, user device 12, or it may be a separate device. A generated result may be sent to user console 26, or a user operating user console 26 may access a generated result via network 14. For example, when a result is generated, processing unit 16 may send a notification to user console 26.

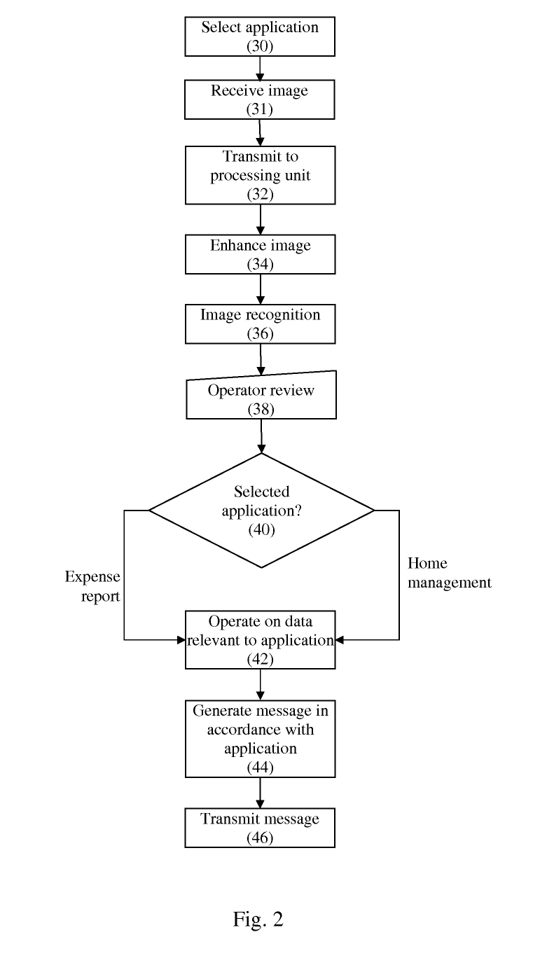

FIG. 2 shows a flowchart illustrating a method for remote receipt analysis, in accordance with embodiments of the present invention. It should be understood that the division of the method into individual steps is for convenience only, and that alternative division into steps may be possible with equivalent results. Also, the order of the steps is for illustration purposes only. Steps of the method may be performed concurrently or in another order with equivalent results. The various alternative divisions of the method into steps, and the various alternative orders of the steps, should be considered as included within the scope of the present invention.

Reference is also made to components of the remote receipt analysis system shown in FIG. 1.

The user may operate user device 12 to indicate to processing unit 16 via network 14 an application to be run on a captured document image (step 30). A user operating user device 12 may capture an image of a receipt or document (step 31). For example, processing unit 16 may communicate with user device 12 or operator console 24 so as to solicit input regarding selection of an application (e.g. during a login process). The user may select an application from a set of applications that are available to the user. For example, available applications may depend on one or more document properties (e.g. title, content), on user status (e.g. business or private, or type of subscription). Alternatively, an application may be selected automatically based on document properties (e.g. after steps 32 through 36), or manually by a system operator selection. Automatic selection of an application may be subject to confirmation by a user or operator. Operator selection may be subject to confirmation by the user.

Processing unit 16 may receive via network 14 the captured document image as submitted by user device 12 (step 32). Processing unit 16 may apply image enhancement operations of image enhancement module 18 to the submitted document image (step 34). For example, application of image enhancement operations may determine which regions of the document image, if any, require image enhancement. For example, image enhancement may render one or more regions of the document image more amenable to interpretation by image recognition module 20.

Processing unit 16 may apply one or more recognition operations of image recognition module 20 to the submitted document image (step 36). For example, recognition operations may include OCR to convert at least part of the image into one or more text strings. Recognition operations may also include identification of a type of data represented by one or more of the text strings. Typically, recognition operations include identifying a text string that represents an amount paid, receipt date, vendor name, or a list of products or services with their itemized prices. OCR operations may be applied to a document as a whole, without consideration of what information is to be extracted. Alternatively, at least some of the recognition operations may be applied in accordance with the selected application. In this case, application of the recognition operations may be directed toward extracting particular data from the document. For example, if an expense report application is selected and the identified document is a receipt, recognition operations (and perhaps image enhancement operations) may be limited to one or more regions of interest of the receipt. For example, the recognition operations may be limited to extracting an amount paid and identification of a vendor.

When image recognition module 20 is unable to extract all required data from the document image, processing unit 16 may solicit input from a human operator via operator console 24. Alternatively, a document image and image recognition results may be submitted to operator console 24 for verification as a routine matter under a variety of predetermined conditions (e.g. type of document, type of application, user provided importance ranking). A human operator may then input corrections or verification via operator console 24 (step 38).

An application module 22 may, on the basis of a selected operation (step 40) operate on recognized data in a manner appropriate to the selected application (step 42).

For example, if an expense report application was selected, an expense report application may extract relevant data from the submitted document. Such relevant data may include identification of the issuer of the receipt, a transaction date, item or service purchased, amount paid, and amount of tax paid. The expense report application may communicate with data storage device 28 in order to receive information such as, for example, approved types of expenditures, and usual price ranges.

If a household management application was selected, a household management application may extract relevant data from the submitted document. Such relevant data may include: identification of store in which purchases were made, products purchased, prices paid, and date of purchase. The household management application may communicate with data storage device 28 in order to store the data in an appropriate database, or to query the database to determine such information as, for example, the prices for similar products at another store.

An application module 22, upon operation on extracted data, may generate an appropriate result (step 44). The type of result may depend on the selected application. Typically, the result is in the form of a message to be sent to a user console 26 (step 46).

For example, if an expense report application was selected, the result may include a generated expense report. Alternatively, if an expense report is to be generated at a future date, the expense report application may store the relevant data on data storage device 28. When the expense report is generated, processing unit 16 may transmit a notification to user console 26 via network 14. For example, user console 26 may be associated with an accounting department.

If a household management application was selected, the result may include a price comparison. For example, a user may be prompted to select, e.g. via user console 26, one or more itemized items on the receipt for a price comparison. In this case, a table or other data structure that includes price comparison information may be generated. The generated price comparison information may be transmitted as a message to user console 26. User console 26 may be identical with user device 12.

A processing unit, in accordance with some embodiments of the present invention, may include an ad generation module. For example, a user may subscribe to an ad service. An ad generation module may analyze a received image of document and extract data from the document. For example, a user device may transmit an image of a store receipt to a processing unit that includes an ad generation module. The ad generation module may identify in the receipt image transaction data as: vendor identifying details such as name address and phone numbers of a store or vendor, a date of purchase, products or services purchased, the price of each product or service and the total price paid.

An ad generation module in accordance with embodiments of the present invention, may maintain a user database associating users, products, prices, various stores and vendors. For example, information from a received receipt image may be added to the user database as the information is acquired. Data may be categorized, for example but not limited to, according to geographic location of the store, vendor category, item category etc. In addition, users may be categorized based on relevant user characteristics. Users' characteristics such as age, gender, address of residence may be supplied manually by the users. Other user characteristics may be derived from the receipts uploaded by the users. For example, users may be categorized based on stores they shop in, location of the stores they shop in, items they purchase etc.

A vendor who wishes to advertize an ad, send coupons or other types of promotions to target population, may define a target users category according to user characteristics such as, but not limited to, stores the user shop in, geographic location of the stores the user shop in, category of items the user purchases, specific items the user purchases, whether the target user is a client of the vendor, a client of competitor or client of accompanying products, etc. Ad generation module, in accordance with embodiments of the present invention, may maintain a vendor database associating vendors, ads and categories of target users. Ad Generator module may retrieve data extracted from the users and vendor databases and may distribute commercial data such as ads, coupons and other types of promotions to target users categories, as defined by the vendors.

In accordance with embodiments of the present invention, ad generation module may send ads addressed to users registered to ad service automatically. Alternatively, ad generation module may send ads addressed to users manually. For example, ad generation module may send ads by demand. For example, ad generation module may send ads to a user in response to demand made by the user to view all ads addressed to him. Alternatively, ad generation module may send relevant ads to a user in response to a demand to view ads published in a specific category, for example, ads published by a specific vendor, ads related to a specific item, ads related to items category, etc. Alternatively, ad generation module may send some of the ads automatically and other ads manually. Ad generation module may send ads automatically or manually to a user based on user's settings. Ad generation module may send ads to users based also on geographic location of the user in case the geographic location of the user is known, for example, in case the user uses a mobile phone with a Global Positioning System (GPS). In addition ad generation module may publish the ads on a system website. The ads may be sent to the user or a user device or console in the form of a text message, a picture, video audio massages, or any combination thereof. The ads may also include discount coupons. Discount coupons may be given as for example, discount codes, paper based coupons, electronic coupons etc.

Ad generation module may provide users with content based offers. For example, Analysis of receipts and other documents uploaded by the users may be used to suggest and/or recommend books and other content to users to whom this may be of interest. For example, based on purchase patterns, the system may recommend additional books, articles, scientific papers, etc., and even blogs or user forums with common subject matter.

According to embodiments of the present invention a human operator may be located either at the processing center, or anywhere around the globe and log on to the system through the internet. Additionally, in order to reduce errors to a minimum, manual data capture step will utilize double typing. Using double typing, data elements that required high accuracy level may be sent to two human operators, who are unaware of what the other is typing. The system may compare the entries typed by the two human operators. If their typing results in the same entries, the system accepts that unified entry as correct. If their typing results are not the same, the content in question may be sent to a third human operator for resolution. Alternatively entries extracted by OCR may be compared against entries typed by a human operator. In addition, entries typed by human operators or extracted by OCR may undergo validity checks, as known in the art. For example, in case a vendor name and phone number are extracted from a receipt, the veracity of the vendor name can be validated by cross-checking the telephone number against published databases

A processing unit, in accordance with some embodiments of the present invention, may include a receipt and warranty storage module. For example, a user may subscribe to a receipt and warranty storage service. A receipt and warranty storage module may analyze a received image of document and extract data from the document. For example, a user device may transmit an image of a store receipt or warranty to a processing unit that includes a receipt and warranty storage module. The receipt and warranty storage module may identify in the receipt or warranty image such information as: vendor identifying details such as name address and phone numbers of a store or vendor, a date of purchase, products purchased, price of each product, total price paid and warranty period. Receipt and warranty storage module may keep receipts and warranty documents for future use.

A processing unit, in accordance with some embodiments of the present invention, may include a general document archive and access module. For example, a user may subscribe to a general document archive and access service. A general document archive and access module may analyze a received image of documents and extract data from the document. For example, a user device may transmit an image of a variety of documents to a processing unit that includes a general document archive and access module. The general document archive and access module may identify content in the document image. Documents may be categorized based on content found in the documents. The documents may be archived and later searched and retrieved base on text found in the documents.

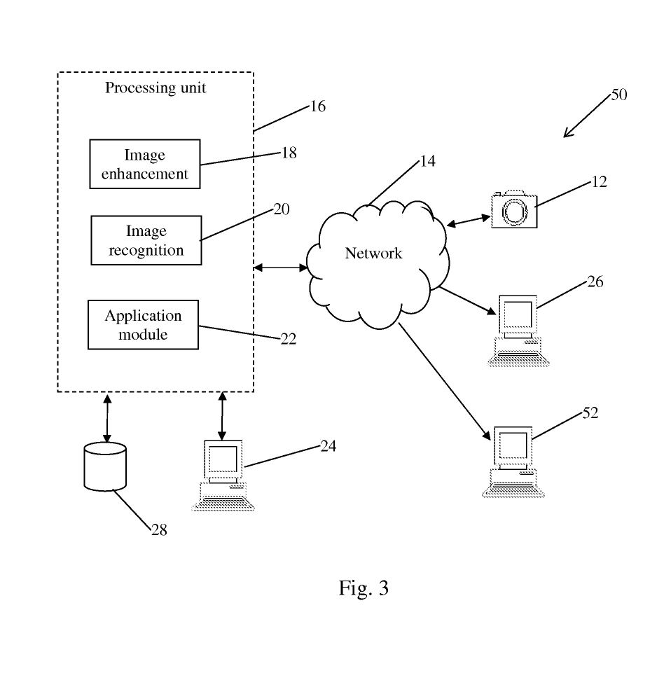

Reference is now made to FIG. 3 depicting a schematic diagram of a targeted advertising system in accordance with embodiments of the present invention. Receipt analysis system 50 may include user device 12 of a user that may communicate with a processing unit 16 via network 14. Processing unit 16 may include an image enhancement module 18, an image recognition module 20 and an application module 22.

Image recognition module 20 may interact with at least one operator console 24. Operator console 24 may enable a human operator to review results of image recognition module 20, to display recipes and other documents uploaded to system 50 to a human operator and to receive typed data from the human operator.

An application module 22 may be configured to provide operations for an application such as ad generation module, a receipt and warranty storage module and general document archive and access module. Application module 22 may communicate with a data storage device 28. For example, a data storage device 28 may include one or more databases, such as user database and vendor database. Application module 22 may add data that was extracted from a submitted receipt to a user database on data storage device 28. Application module 22 may add data that was entered through vendor console 52 to a vendor database on data storage device 28. Additionally, application module 22 may use data received from vendor console 52 or extracted from the vendor database to query the user database on data storage device 28. For example, an ad generation application may add price data from a submitted shopping receipt to a user database, or query the user database in order to find users that full into a category selected by a vendor through vendor console 52. Application module 22 may deliver commercial data such as ads, coupons and other types of promotions, via network 14, to user console 26 of the same user of user device 12, based on a target users category selected by the vendor through vendor console 52. User console 26 may be identical to, or associated with, user device 12, or it may be a separate device. Throughout the application the term console may refer to any type of computing device including input and output capabilities and with access to the Internet, such as, but not limited to a personal computer (PC) a portable computer, a hand held device, a tablet computer, a pad, a mobile phone or handset such as a smartphone etc.

Commercial data may be sent to user console 26, or a user operating user console 26 may access commercial data via network 14. For example, when commercial data is generated, processing unit 16 may send a notification to user console 26.

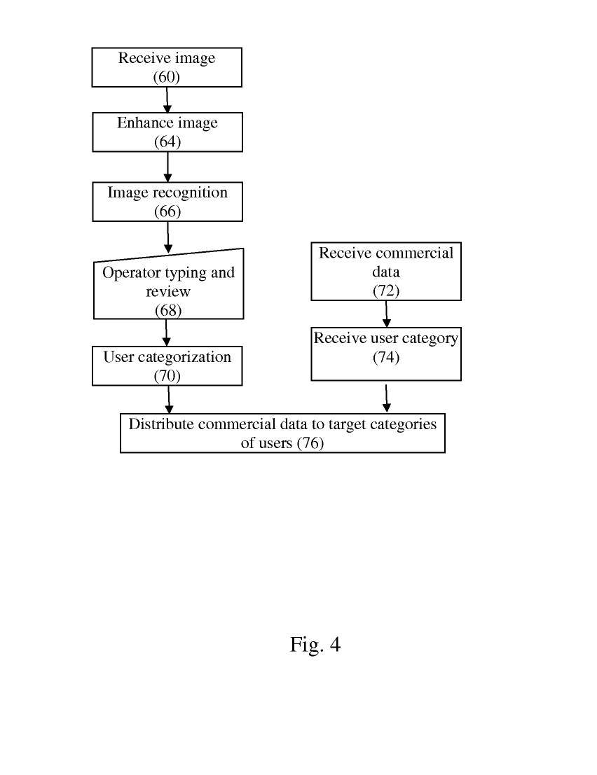

Reference is now made to FIG. 4 which shows a flowchart illustrating a method for targeted advertising, in accordance with embodiments of the present invention. It should be understood that the division of the method into individual steps is for convenience only, and that alternative division into steps may be possible with equivalent results. Also, the order of the steps is for illustration purposes only. Steps of the method may be performed concurrently or in another order with equivalent results. The various alternative divisions of the method into steps, and the various alternative orders of the steps, should be considered as included within the scope of the present invention.

A captured document image as submitted by a user may be received 60 and enhanced 64. For example, application of image enhancement operations may determine which regions of the document image, if any, require image enhancement. For example, image enhancement may render one or more regions of the document image more amenable to interpretation. Recognition operations may be applied 66, for example, operations may include OCR to convert at least part of the image into one or more text strings. Additionally, recognition operations may include various intelligent document understanding technologies used for content analysis and categorization. Optionally, text may be typed or verified 68 by a human operator. Users may be categorized for example, based on stores they shop in, location of the stores they shop in, items they purchase etc. commercial data such as ads, coupons and other promotion material by be received 72 from vendors. In addition target users categories may be received from the vendor. The commercial data may be distributed 76 to users pertaining to users categories specified by the vendor.

It should be clear that the description of the embodiments and attached Figures set forth in this specification serve only for a better understanding of the invention, without limiting its scope.

It should also be clear that a person skilled in the art, after reading the present specification could make adjustments or amendments to the attached Figures and above described embodiments that would still be covered by the present invention.

1. A method for targeted advertising, the method comprising:
receiving an image of a receipt that was acquired by a user device of a user and sent over a network;
automatically performing optical character recognition on the image of the receipt to obtain a machine-encoded text;
automatically extracting transaction data from the machine-encoded text; and
automatically distributing commercial data to a user console of the user based on the transaction data.

2. A method as claimed in claim 1, wherein the transaction data comprises items selectable from a list comprising: vendor name, vendor phone number, store address, date of purchase, products purchased, price of each product and the total price paid.

3. A method as claimed in claim 1, wherein automatically distributing commercial data to the user console comprises:
querying a user database, said user database associating users, products, prices and various stores and vendors;
querying a vendor database associating vendors, ads and categories of target users; and
distributing commercial data to a selected category of target users as defined by the vendor database.

4. A method as claimed in claim 3, wherein said categories of target users is defined based on user characteristics selectable from a list comprising: geographic location of stores a user shop in, category of items the user purchases, specific items the user purchases and the stores the user shop in.

5. A method as claimed in claim 1, wherein distributing commercial data to the user console comprises sending commercial data addressed to the user console automatically.

6. A method as claimed in claim 1, wherein distributing commercial data to the user console comprises sending commercial data addressed to the user console on demand.

7. A method as claimed in claim 1, wherein said commercial data comprises ads and coupons.

8. A method as claimed in claim 1, comprising:
soliciting input from a plurality of operators; and
comparing input received from said plurality of operators.

9. A computer program product stored on a non-transitory tangible computer readable storage medium for targeted advertising, the computer program including code for:
receiving an image of a receipt that was acquired by a user device of a user and sent over a network;
automatically performing optical character recognition on the image of the receipt to obtain a machine-encoded text;
automatically extracting transaction data from the machine-encoded text; and
automatically distributing commercial data to a user console of the user based on the transaction data.

10. A computer program product as claimed in claim 9, wherein the transaction data comprises items selectable from a list comprising: vendor name, vendor phone number, store address, date of purchase, products purchased, price of each product and the total price paid.

11. A computer program product as claimed in claim 9, wherein automatically distributing commercial data to the user console comprises:
querying a user database, said user database associating users, products, prices and various stores and vendors;
querying a vendor database associating vendors, ads and categories of target users; and
distributing commercial data to a selected category of target users as defined by the vendor database.

12. A computer program product as claimed in claim 10, wherein said categories of target users is defined based on user characteristics selectable from a list comprising: geographic location of stores a user shop in, category of items the user purchases, specific items the user purchases and the stores the user shop in.

13. A computer program product as claimed in claim 9, wherein distributing commercial data to the user console comprises sending commercial data addressed to the user console automatically.

14. A computer program product as claimed in claim 9, wherein distributing commercial data to the user console comprises sending commercial data addressed to the user console on demand.

15. A computer program product as claimed in claim 9, wherein said commercial data comprises ads and coupons.

16. A computer program product as claimed in claim 9, comprising:
soliciting input from a plurality of operators; and
comparing input received from said plurality of operators.

17. A data processing system comprising:
a processor; and
a computer usable medium connected to the processor, wherein the computer usable medium contains a set of instructions for targeted advertising, wherein the processor is designed to carry out a set of instructions to:
receive an image of a receipt that was acquired by a user device of a user and sent over a network;
automatically perform optical character recognition on the image of the receipt to obtain a machine-encoded text;
automatically extract transaction data from the machine-encoded text; and
automatically distribute commercial data to a user console of the user based on the transaction data.

18. A data processing system as claimed in claim 17, wherein the transaction data comprises items selectable from a list comprising: vendor name, vendor phone number, store address, date of purchase, products purchased, price of each product and the total price paid.

19. A data processing system as claimed in claim 17, wherein automatically distributing commercial data to the user console comprises:
querying a user database, said user database associating users, products, prices and various stores and vendors;
querying a vendor database associating vendors, ads and categories of target users; and
distributing commercial data to a selected category of target users as defined by the vendor database.

20. A data processing system as claimed in claim 19, wherein said categories of target users is defined based on user characteristics selectable from a list comprising: geographic location of stores a user shop in, category of items the user purchases, specific items the user purchases and the stores the user shop in.

21. A data processing system as claimed in claim 17, wherein distributing commercial data to the user console comprises sending commercial data addressed to the user console automatically.

20. A data processing system as claimed in claim 17, wherein distributing commercial data to the user console comprises sending commercial data addressed to the user console on demand.

21. A data processing system as claimed in claim 17, wherein said commercial data comprises ads and coupons.

22. A data processing system as claimed in claim 17, wherein the processor is designed to carry out a set of instructions further to:
solicit input from a plurality of operators; and
compare input received from said plurality of operators.
